(19) United States
(12) Patent Application Publication
(10) Pub. No.: US 2021/0082421 A1
(43) Pub. Date: Mar. 18, 2021

(54) METHOD AND DEVICE FOR SPEECH PROCESSING

(71) Applicant: LG ELECTRONICS INC., Seoul (KR)

(72) Inventors: Sang Ki KIM, Seoul (KR); Yongchul PARK, Seoul (KR); Minook KIM, Seoul (KR); Siyoung YANG, Seoul (KR); Juyeong JANG, Seoul (KR); Sungmin HAN, Seoul (KR)

(73) Assignee: LG ELECTRONICS INC., Seoul (KR)

(21) Appl. No.: 16/676,160

(22) Filed: Nov. 6, 2019

(30) Foreign Application Priority Data
Sep. 16, 2019 (KR) 10-2019-0113611

(51) Int. Cl. G10L 15/22; G10L 25/84; G10L 13/04; G10L 15/30

(52) U.S. Cl. CPC G10L 15/22; G10L 25/84; G10L 2015/228; G10L 15/30; G10L 2015/223; G10L 13/043

(57) ABSTRACT

Disclosed are a speech processing method and a speech processing apparatus, characterized in that a speech processing is carried out by executing an artificial intelligence (AI) algorithm and/or a machine learning algorithm, such that the speech processing apparatus, a user terminal, and a server can communicate with each other in a 5G communication environment. The speech processing method according to one exemplary embodiment of the present invention includes converting a response text, which is generated in response to a spoken utterance of a user, to a spoken response utterance, obtaining external situation information while outputting the spoken response utterance, generating a dynamic spoken response utterance by converting the spoken response utterance on the basis of the external situation information, and outputting the dynamic spoken response utterance.

### CROSS-REFERENCE TO RELATED APPLICATION

Pursuant to 35 U.S.C. § 119(a), this application claims the benefit of earlier filing date and right of priority to Korean Patent Application No. 10-2019-0113611, filed on Sep. 16, 2019, the contents of which are hereby incorporated by reference herein in its entirety.

### BACKGROUND

### 1. Technical Field

The present invention relates to a speech processing method and a speech processing device and, more particularly, to a speech processing method and a speech processing device, characterized in that a text-to-speech (TTS) converter outputs a spoken response utterance, and depending on external situation information obtained while the spoken response utterance is outputted, a dynamic spoken response utterance is generated and outputted.

### 2. Description of Related Art

Voice is the most natural means for communication, information transfer, and language implementation. Voice is a sound with meanings that is uttered by human beings.

Attempts for enabling communications between humans and machines through voice have been continuously made. Furthermore, the field of speech information technology (SIT), which is for processing speech information effectively, has made remarkable progress. Accordingly, SIT has become more widely used in people's real life. Speech recognition, which is included in the SIT, is a technique by which spoken utterance is recognized and converted to text.

Related art 1 (Korean Patent Publication No. 10-2010-0117284 (Nov. 3, 2010)) discloses a remote propagation apparatus having a TTS module and a control method thereof, and describes that the remote propagation apparatus equipped with a TTS module is installed in an area that is predicted to suffer a natural disaster or an area that is considered as vulnerable in a jurisdiction, and only broadcasting data is transmitted to the remote propagation apparatus from a server or a person in charge and then is converted to voice, to thereby make an announcement.

Related art 2 (Korean Patent Publication No. 10-2011-0066409 (Jun. 17, 2011)) discloses a user-customized broadcasting service method using a TTS technology, characterized in that the TTS technology and a user-customized broadcasting service are combined and applied, such that only broadcasting program information necessary for a user is outputted as a voice.

However, the TTS systems disclosed in related arts 1 and 2 continue outputting spoken utterance regardless of surrounding noise, or suddenly stop the output of spoken utterance when a wake-up word is received. As a result, concentration of users on the speech of the TTS system can easily be reduced, and thus the message of the speech can be inaccurately recognized by the user.

The above-described background technology is technical information that the inventors have held for the derivation of the present disclosure or that the inventors acquired in the process of deriving the present disclosure. Thus, the above-described background technology cannot be regarded as known technology disclosed to the general public prior to the filing of the present application.

### SUMMARY OF THE INVENTION

An aspect of the present disclosure is directed to providing a speech processing method and apparatus characterized in that a dynamic spoken response utterance is generated and outputted on the basis of external situation information obtained while a spoken response utterance that is converted by a TTS converter is outputted.

An aspect of the present disclosure is directed to providing a speech processing method and apparatus characterized in that a dynamic spoken response utterance is generated and outputted on the basis of information on a direct response of a user to a spoken response utterance that is converted and outputted by a TTS converter.

An aspect of the present disclosure is directed to providing a speech processing method and apparatus characterized in that a dynamic spoken response utterance is generated and outputted on the basis of indirect audio information of surroundings obtained while a spoken response utterance that is converted by a TTS converter is outputted.

An aspect of the present disclosure is directed to providing a speech processing method and apparatus characterized in that a dynamic spoken response utterance is generated and outputted on the basis of time limit information received while a spoken response utterance that is converted by a TTS converter is outputted.

The TTS systems disclosed in the related arts continue outputting spoken utterance regardless of surrounding noise, or suddenly stop outputting spoken utterance when a wake-up word is received. As a result, concentration of the user on the utterance spoken by the TTS systems can easily be reduced, and thus the message of the spoken utterance can be inaccurately recognized by the user. An aspect of the present disclosure is directed to addressing such deficiencies of the related arts by using optimal processes and resources.

### Solution to Problem

According to an exemplary embodiment of the present disclosure, a speech processing method may include generating and outputting a dynamic spoken response utterance on the basis of external situation information obtained while a spoken response utterance that is converted by a TTS converter is outputted.

More specifically, the speech processing method, according to an exemplary embodiment of the present disclosure, may include converting a response text, which is generated in response to a spoken utterance of a user, to a spoken response utterance, obtaining external situation information while outputting the spoken response utterance, generating a dynamic spoken response utterance by converting the spoken response utterance on the basis of the external situation information, and outputting the dynamic spoken response utterance.

Through the speech processing method according to the present embodiment, the dynamic spoken response utterance may be generated and outputted on the basis of the external situation information obtained while the spoken response utterance that is converted by the TTS converter is outputted, to thereby improve speech recognition performance.

Furthermore, obtaining the external situation information may include: measuring noise, as the external situation information, inputted through a microphone after outputting the spoken response utterance; determining a noise that exceeds a first reference value as a first noise, which is direct response information of the user; and determining a noise that exceeds a second reference value and is less than the first reference value as a second noise, which is indirect audio information of surroundings.

Furthermore, generating the dynamic spoken response utterance may include generating a first dynamic spoken response utterance by inserting a silent section into the spoken response utterance in response to a determination that the noise is the first noise.

Furthermore, generating the dynamic spoken response utterance may include generating the first dynamic spoken response utterance until the first noise becomes less than the first reference value, and when the first noise becomes less than the first reference value, stopping inserting the silent section and resuming generating the spoken response utterance.

Furthermore, the speech processing method according to the present embodiment may further include outputting a prestored utterance after stopping inserting the silent section and prior to resuming outputting the spoken response utterance.

Furthermore, generating the dynamic spoken response utterance may include generating a second dynamic spoken response utterance by increasing a volume of the spoken response utterance or by increasing a pitch of the spoken response utterance in response to a determination that the noise is the second noise.

Furthermore, generating the dynamic spoken response utterance may include generating the second dynamic spoken response utterance until the second noise becomes less than the second reference value, and when the second noise becomes less than the second reference value, stopping generating the second dynamic spoken response utterance and resuming generating the spoken response utterance.

Furthermore, obtaining the external situation information may include obtaining time limit information, based on which output of the spoken response utterance should be stopped within a predetermined time.

Furthermore, generating the dynamic spoken response utterance may include generating a third dynamic spoken response utterance by changing an output rate of the spoken response utterance on the basis of the time limit information.

A speech processing apparatus, according to an exemplary embodiment of the present disclosure, may include one or more processors configured to convert a response text, which is generated in response to a spoken utterance of a user, to a spoken response utterance, obtain external situation information while outputting the spoken response utterance, generate a dynamic spoken response utterance by converting the spoken response utterance on the basis of the external situation information, and output the dynamic spoken response utterance.

Through the speech processing apparatus according to the present embodiment, the dynamic spoken response utterance may be generated and outputted on the basis of the external situation information obtained while the spoken response utterance that is converted by the TTS converter is outputted, to thereby improve speech recognition performance.

Furthermore, while obtaining the external situation information, the one or more processors may be configured to: measure noise, as the external situation information, inputted through a microphone after outputting the spoken response utterance; determine a noise that exceeds a first reference value as a first noise, which is direct response information of the user; and determine a noise that exceeds a second reference value and is less than the first reference value as a second noise, which is indirect audio information of surroundings.

Furthermore, while generating the dynamic spoken response utterance, the one or more processors may be configured to generate a first dynamic spoken response utterance by inserting a silent section into the spoken response utterance in response to a determination that the noise is the first noise.

Furthermore, while generating the dynamic spoken response utterance, the one or more processors may be configured to generate the first dynamic spoken response utterance until the first noise becomes less than the first reference value, and when the first noise becomes less than the first reference value, stop inserting the silent section and resume generating the spoken response utterance.

Furthermore, the one or more processors may be further configured to output a prestored utterance, after stopping inserting the silent section and prior to resuming generating the spoken response utterance.

Furthermore, while generating the dynamic spoken response utterance, the one or more processors may be configured to generate a second dynamic spoken response utterance by increasing a volume of the spoken response utterance or by increasing a pitch of the spoken response utterance, in response to a determination that the noise is the second noise.

Furthermore, while generating the dynamic spoken response utterance, the one or more processors may be configured to generate the second dynamic spoken response utterance until the second noise becomes less than the second reference value, and when the second noise becomes less than the second reference value, stop generating the second dynamic spoken response utterance and resume generating the spoken response utterance.

Furthermore, while obtaining the external situation information, the one or more processors may be configured to obtain time limit information, based on which output of the spoken response utterance should be stopped within a predetermined time.

Furthermore, the one or more processors may be configured to generate a third dynamic spoken response utterance by changing an output rate of the spoken response utterance on the basis of the time limit information.

Apart from those described above, another method and another system for implementing the present disclosure, and a computer-readable recording medium having a computer program stored therein to perform the method may be further provided.

Other aspects and features as well as those described above will become clear from the accompanying drawings, the claims, and the detailed description of the present disclosure.

### Advantageous Effects of Invention

According to the present disclosure, as the dynamic spoken response utterance is generated and outputted on the basis of the external situation information obtained while the spoken response utterance that is converted by the TTS converter is outputted, speech recognition performance may be improved.

In addition, as the dynamic spoken response utterance is generated and outputted on the basis of the external situation information obtained while the spoken response utterance that is converted by the TTS converter is outputted, the user may be able to focus better while listening, and thus the message of the spoken utterance of the TTS converter may be more accurately recognized by the user.

In addition, as the dynamic spoken response utterance generated by changing an output rate of the spoken response utterance on the basis of the time limit information obtained while the spoken response utterance that is converted by the TTS converter is outputted, speech recognition performance may be improved.

In addition, although the speech processing apparatus is a mass-produced product, the user may consider the speech processing apparatus as a user-customized apparatus. Therefore, the speech processing apparatus may have effects of a user-customized apparatus.

Also, the present disclosure may increase user satisfaction by providing various services through speech recognition processing, and the speech recognition processing may be performed rapidly and accurately.

In addition, only optimal processes and resources are used for outputting the dynamic spoken response utterance which is generated on the basis of the external situation information obtained while the spoken response utterance is outputted. Accordingly, power efficiency of the speech processing apparatus may be significantly improved.

The effects of the present disclosure are not limited to those mentioned above, and other effects not mentioned can be clearly understood by those skilled in the art from the following description.

### BRIEF DESCRIPTION OF THE DRAWINGS

The foregoing and other aspects, features, and advantages of the invention, as well as the following detailed description of the embodiments, will be better understood when read in conjunction with the accompanying drawings. For the purpose of illustrating the present disclosure, there is shown in the drawings an exemplary embodiment, it being understood, however, that the present disclosure is not intended to be limited to the details shown because various modifications and structural changes may be made therein without departing from the spirit of the present disclosure and within the scope and range of equivalents of the claims. The use of the same reference numerals or symbols in different drawings indicates similar or identical items.

FIG. 1 is an illustration of a speech processing environment including a speech processing apparatus, a user terminal, a server, and a network connecting the speech processing apparatus, the user terminal, and the server to one another, according to an exemplary embodiment of the present disclosure.

FIG. 2 is an illustration of the appearance of a speech processing apparatus according to an exemplary embodiment of the present disclosure.

FIG. 3 is a schematic block diagram illustrating a speech processing apparatus according to an exemplary embodiment of the present disclosure.

FIG. 4 is a schematic block diagram illustrating an information processor of the speech processing apparatus shown in FIG. 3, according to an example embodiment.

FIG. 5 is an illustration of a dynamic spoken response utterance which is generated on the basis of external situation information obtained while a spoken response utterance is outputted, according to an exemplary embodiment of the present disclosure.

FIG. 6 is a flowchart of a speech processing method according to an exemplary embodiment of the present disclosure.

### DETAILED DESCRIPTION

The advantages and features of the present disclosure and methods to achieve them will be apparent from the embodiments described below in detail in conjunction with the accompanying drawings. However, the description of particular exemplary embodiments is not intended to limit the present disclosure to the particular exemplary embodiments disclosed herein, but on the contrary, it should be understood that the present disclosure is to cover all modifications, equivalents and alternatives falling within the spirit and scope of the present disclosure. The exemplary embodiments disclosed below are provided so that the present disclosure will be thorough and complete, and also to provide a more complete understanding of the scope of the present disclosure to those of ordinary skill in the art. In the interest of clarity, not all details of the relevant art are described in detail in the present specification if it is determined that such details are not necessary to obtain a complete understanding of the present disclosure.

The shapes, sizes, ratios, angles, the number of elements given in the drawings are merely exemplary, and thus, the present disclosure is not limited to the illustrated details. Like reference numerals designate like elements throughout the specification.

In relation to describing the present disclosure, when the detailed description of the relevant known technology is determined to unnecessarily obscure the gist of the present disclosure, the detailed description may be omitted.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

As used herein, the expressions “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” includes the following meanings: A alone; B alone; C alone; both A and B together; both A and C together; both B and C together; and all three of A, B, and C together. Further, these expressions are open-ended, unless expressly designated to the contrary by their combination with the term “consisting of:” For example, the expression “at least one of A, B, and C” may also include an nth member, where n is greater than 3, whereas the expression “at least one selected from the group consisting of A, B, and C” does not.

Hereinafter, embodiments of the present disclosure will be described in detail with reference to the accompanying drawings. Like reference numerals designate like elements throughout the specification, and overlapping descriptions of the elements will be omitted.

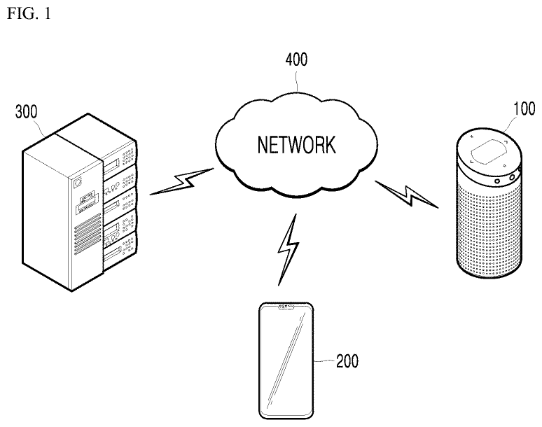

FIG. 1 is an illustration of a speech processing environment including a speech processing apparatus, a user terminal, a server, and a network connecting the speech processing apparatus, the user terminal, and the server to one another, according to an exemplary embodiment of the present disclosure. Referring to FIG. 1, the speech processing environment may include a speech processing apparatus 100, a user terminal 200, a server 300, and a network 400. The speech processing apparatus 100, the user terminal 200, and the server 300 may be connected to one another in a 5G communication environment. In addition, other than the devices illustrated in FIG. 1, various other electronic devices for use at home or office may be connected to one another and operate in an Internet-of-Things (IoT) environment.

The speech processing apparatus 100 may receive a spoken utterance from a user and provide a speech recognition service through recognition and analysis of the spoken utterance. In the present embodiment, the speech processing apparatus 100 may include various electronic devices capable of performing speech recognition functions, such as an artificial intelligence (AI) speaker or a communication robot. In addition, the speech processing apparatus 100 may serve as a hub which controls an electronic device that does not have a speech input/output function. Here, the speech recognition service denotes a service that receives a spoken utterance of a user, identifies a wake-up word and a spoken sentence from the spoken utterance, and then outputs the result of a speech recognition processing of the spoken sentence so that the user is able to recognize the result.

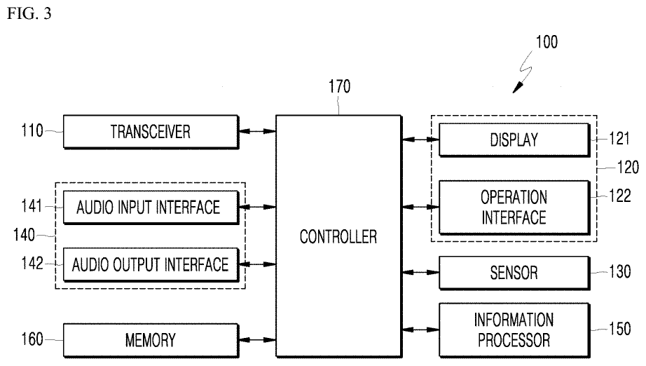

Here, the spoken utterance may contain a wake-up word and a spoken sentence. The wake-up word may be a specific command that activates the speech recognition function of the speech processing apparatus 100. The speech recognition function is activated only when the wake-up word is present in the spoken utterance, and therefore, when the spoken utterance does not contain the wake-up word, the speech recognition function may remain inactive (for example, a sleep mode). Such a wake-up word may be preset and stored in a memory (160 in FIG. 3) which will be described later.

In addition, the spoken sentence may be a voice command of the user, which is processed after the speech recognition function of the speech processing apparatus 100 is activated. The speech processing apparatus 100 may substantially process the voice command and generate an output. For example, when the user's spoken utterance is “Hi LG, turn on the air conditioner,” the wake-up word in the spoken utterance may be “Hi LG,” and the spoken sentence may be “turn on the air conditioner.” The speech processing apparatus 100 may receive and analyze the spoken sentence, determine the presence of the wake-up word therein, and then execute the spoken sentence, to thereby control an air conditioner (not illustrated) as an electronic device.

In the present embodiment, the speech processing apparatus 100 may convert a response text, which is generated in response to a spoken utterance of the user, to a spoken response utterance, while the speech recognition function is active after a wake-up word is received.

When the spoken response utterance is outputted through a speaker (an audio output interface 142 in FIG. 3), the speech processing apparatus 100 may obtain external situation information while the spoken response utterance is outputted. In the present embodiment, the speech processing apparatus 100 may measure noise as the external situation information and determine whether the noise is a first noise or a second noise. Accordingly, the external situation information obtained by the speech processing apparatus 100 may include the first noise and the second noise.

Here, the first noise of the external situation information may be a noise exceeding a first reference value (for example, 60 dB), and include direct reaction information of the user (and a listener) for the outputted spoken response utterance. For example, the direct reaction information may include, for example, clapping and acclamation. In addition, the first noise may not be a real noise and may include an external interruption.

The second noise of the external situation information may be a noise that exceeds a second reference value (for example, 30 dB) and is less than the first reference value, and may include indirect audio information of surroundings obtained while the spoken response utterance is outputted. The indirect audio information may include, for example, ambient noise. Here, the second noise may be a noise related to the outputted spoken response utterance. For example, the second noise may include a noise of the user that exceeds the second reference value and is less than the first reference value, or a noise unrelated to the outputted spoken response utterance, such as the sound of a passing car.

The external situation information may include time limit information for setting output time of the spoken response utterance. Here, the time limit information may include time setting information, based on which the output of the spoken response utterance should be stopped within a predetermined time.

The speech processing apparatus 100 may generate a dynamic spoken response utterance by converting the spoken response utterance on the basis of the external situation information, and output the dynamic spoken response utterance or the spoken response utterance through the speaker. The speech processing apparatus 100 may generate a first dynamic spoken response utterance by inserting a silent section into the spoken response utterance in response to a determination that the noise is the first noise. Furthermore, the speech processing apparatus 100 may generate a second dynamic spoken response utterance by increasing the volume of the spoken response utterance or by increasing the pitch of the spoken response utterance in response to a determination that the noise is the second noise. Furthermore, the speech processing apparatus 100 may generate a third dynamic spoken response utterance by changing the output rate of the spoken response utterance on the basis of the time limit information.

The speech processing apparatus 100 may generate the first dynamic spoken response utterance until the first noise becomes less than the first reference value, and when the first noise becomes less than the first reference value, stop inserting the silent section and resume outputting the spoken response utterance. Here, when the first noise exceeds the second reference value and is less than the first value while the first dynamic spoken response utterance is outputted, the speech processing apparatus 100 may determine that the noise is the second noise and generate the second dynamic spoken response utterance by increasing the volume or pitch of the spoken response utterance. When the second noise becomes less than the second reference value while the second dynamic spoken response utterance is generated, the speech processing apparatus 100 may stop generating the second dynamic spoken response utterance and resume outputting the spoken response utterance.

In addition, when the set time included in the time limit information is reached while the third dynamic spoken response utterance is generated, the speech processing apparatus 100 may stop generating the third dynamic spoken response utterance.

After accessing a speech processing application or a speech processing site and going through an authentication process, the user terminal 200 may be provided with a service for monitoring status information of the speech processing apparatus 100, or for operating or controlling the speech processing apparatus 100. In the present embodiment, when the user terminal 200, for example, receives a spoken utterance of the user after going through the authentication process, the user terminal 200 may determine an operation mode of the speech processing apparatus 100 to operate the speech processing apparatus 100 or may control operation of the speech processing apparatus 100.

The user terminal 200 may include a communication terminal capable of executing a function of a computing device (not shown). In the present embodiment, the user terminal 200 may include, but is not limited to, a desktop computer, a smart phone, a laptop computer, a tablet PC, a smart TV, a cell phone, a personal digital assistant (PDA), a media player, a micro server, a global positioning system (GPS) device, an electronic book reader, a digital broadcast terminal, a navigation device, a kiosk, an MP3 player, a digital camera, home appliance, and other mobile or immobile computing devices operated by the user. Furthermore, the user terminal 200 may be a wearable terminal having a communication function and a data processing function, such as a watch, glasses, a hair band, or a ring. The user terminal 200 is not limited to the above-mentioned devices, and thus any terminal that supports web browsing may be adopted.

The server 300 may be a database server, which provides big data required for applying a variety of artificial intelligence algorithms and data related to speech recognition. Furthermore, the server 300 may include a web server or application server that enables remote control of the speech processing apparatus 100 by using an application or web browser installed on the user terminal 200.

Artificial intelligence (AI) is an area of computer engineering science and information technology that studies methods to make computers mimic intelligent human behaviors such as reasoning, learning, self-improving, and the like.

In addition, artificial intelligence does not exist on its own, but is rather directly or indirectly related to a number of other fields in computer science. In recent years, there have been numerous attempts to introduce an element of the artificial intelligence into various fields of information technology to solve problems in the respective fields.

Machine learning is an area of artificial intelligence that includes the field of study that gives computers the capability to learn without being explicitly programmed. Specifically, machine learning may be a technology for researching and constructing a system for learning, predicting, and improving its own performance based on empirical data and an algorithm for the same. Machine learning algorithms, rather than only executing rigidly-set static program commands, may be used to take an approach that builds models for deriving predictions and decisions from inputted data.

The server 300 may perform the speech recognition function of the speech processing apparatus 100. The server 300 may generate a response text in response to a spoken utterance of the user that is received from the speech processing apparatus 100, convert the response text to a spoken response utterance, and transmit the spoken response utterance to the speech processing apparatus 100. The server 300 may generate at least one of a first dynamic spoken response utterance, a second dynamic spoken response utterance, or a third dynamic spoken response utterance on the basis of external situation information received from the speech processing apparatus 100, and then transmit the generated dynamic spoken response utterance to the speech processing apparatus 100.

Depending on the processing capability of the speech processing apparatus 100, the speech processing apparatus 100 may perform, in addition to the speech recognition function, at least a part of converting the response text, which is generated in response to the spoken utterance of the user, to the spoken response utterance or generating the dynamic spoken response utterance by converting the spoken response utterance on the basis of the external situation information.

The network 400 may connect the speech processing apparatus 100, the user terminal 200, and the server 300 to one another. The network 400 may include a wired network such as a local area network (LAN), a wide area network (WAN), a metropolitan area network (MAN), or an integrated service digital network (ISDN), and a wireless network such as a wireless LAN, a CDMA, Bluetooth®, or satellite communication, but the present disclosure is not limited to these examples. The network 400 may send and receive information by using short distance communication and/or long distance communication. The short distance communication may include Bluetooth®, radio frequency identification (RFID), infrared data association (IrDA), ultra-wideband (UWB), ZigBee, and wireless fidelity (Wi-Fi) technologies, and the long distance communication may include code division multiple access (CDMA), frequency division multiple access (FDMA), time division multiple access (TDMA), orthogonal frequency division multiple access (OFDMA), and single carrier frequency division multiple access (SC-FDMA).

The network 400 may include a connection of network elements such as a hub, a bridge, a router, a switch, and a gateway. The network 400 may include one or more connected networks, for example, a multi-network environment, including a public network such as an Internet and a private network such as a safe corporate private network. The access to the network 400 may be provided via one or more wired or wireless access networks. Further, the network 400 may support 5G communications and/or an Internet of things (IoT) network for exchanging and processing information between distributed components such as objects.

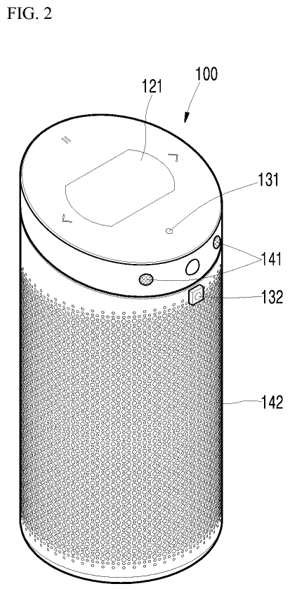

FIG. 2 is an illustration of the appearance of a speech processing apparatus according to an exemplary embodiment of the present disclosure, and

FIG. 3 is a schematic block diagram illustrating a speech processing apparatus according to an exemplary embodiment of the present disclosure. Hereinafter, description overlapping with that of FIG. 1 will be omitted. Referring to FIG. 2 and FIG. 3, the speech processing apparatus 100 may include a transceiver 110, a user interface 120 including a display 121 and an operation interface 122, a sensor 130, an audio processor 140 including an audio input interface 141 and an audio output interface 142, an information processor 150, a memory 160, and a controller 170.

The transceiver 110 may interwork with the network 400 to provide a communication interface required for providing, in the form of packet data, transmission and reception signals among the speech processing apparatus 100 and/or the user terminal 200 and/or the server 300. Furthermore, the transceiver 110 may receive an information request signal from the user terminal 200, and transmit information that has been processed by the speech processing apparatus 100 to the user terminal 200. Furthermore, the transceiver 110 may transmit the information request signal received from the user terminal 200 to the server 300, receive a response signal that has been processed by the server 300, and then transmit the response signal to the user terminal 200. Furthermore, the transceiver 110 may be a device including hardware and software required for transmitting and receiving signals such as a control signal and a data signal via a wired or wireless connection to another network device.

Furthermore, the transceiver 110 may support a variety of object-to-object intelligent communication, for example, Internet of things (IoT), Internet of everything (IoE), and Internet of small things (IoST), and may support, for example, machine to machine (M2M) communication, vehicle to everything (V2X) communication, and device to device (D2D) communication.

The display 121 of the user interface 120 may display a driving state of the speech processing apparatus 100 under control of the controller 170. Depending on the embodiment, the display 121 may form an inter-layer structure with a touch pad so as to be configured as a touch screen. Here, the display 121 may also be used as the operation interface 122 capable of inputting information through a touch of a user. To this end, the display 121 may be configured with a touch recognition display controller or other various input and output controllers. As an example, the touch recognition display controller may provide an output interface and an input interface between device and user. The touch recognition display controller may transmit and receive electric signals to and from the controller 170. Also, the touch recognition display controller may display a visual output to the user, and the visual output may include texts, graphics, images, video, and combinations thereof. The display 121 may be a predetermined display member, such as a touch-sensitive organic light emitting display (OLED), liquid crystal display (LCD), or light emitting display (LED).

The operation interface 122 of the user interface 120 may have a plurality of operation buttons (not illustrated) to transmit signals corresponding to the buttons to the controller 170. The operation interface 122 may be configured with a sensor, a button, or a switch structure capable of recognizing a touch or a pressing operation of the user. In the present embodiment, the operation interface 122 may transmit, to the controller 170, an operation signal generated by the user to check various information regarding the operation of the speech processing apparatus 100 displayed on the display 121, or to modify the operation of the speech processing apparatus 100.

The sensor 130 may include various sensors configured to sense the surroundings of the speech processing apparatus 100. The sensor 130 may include a proximity sensor 131 and an image sensor 132. The proximity sensor 131 may acquire location data of an object (for example, the user) located in an area surrounding the speech processing apparatus 100 by using, for example, infrared rays. Furthermore, the location data of the user acquired by the proximity sensor 131 may be stored in the memory 160.

The image sensor 132 may include a camera (not illustrated) capable of capturing an image of the surroundings of the speech processing apparatus 100, and a plurality of cameras may be installed for image-capturing efficiency. For example, each camera may include an image sensor (for example, a CMOS image sensor) which includes at least one optical lens and a plurality of photodiodes (for example, pixels) forming an image using the light passing through the optical lens, and may include a digital signal processor (DSP) for configuring an image on the basis of signals outputted from the photodiodes. The DSP may generate not only a static image but also a video formed of frames of static images. The image captured and acquired by the camera serving as the image sensor 132 may be stored in the memory 160.

In the present embodiment, the sensor 130 includes the proximity sensor 131 and the image sensor 132, but is not limited thereto. For example, the sensor 130 may include at least one of a lidar sensor, a weight sensor, an illumination sensor, a touch sensor, an acceleration sensor, a magnetic sensor, a G-sensor, a gyroscope sensor, a motion sensor, an RGB sensor, an infrared (IR) sensor, a finger scan sensor, an ultrasonic sensor, an optical sensor, a microphone, a battery gauge, an environmental sensor (for example, a barometer, a hygrometer, a thermometer, a radiation detection sensor, a heat detection sensor, or a gas detection sensor) or a chemical sensors (for example, an electronic nose, a healthcare sensor, or a biometric sensor). In the present embodiment, the speech processing apparatus 100 may combine various information sensed by at least two of the above-mentioned sensors, and use the combined information.

The audio input interface 141 of the audio processor 140 may receive a spoken utterance (for example, a wake-up word and a spoken sentence) of the user inputted thereto and transmit the received spoken utterance to the controller 170. Then, the controller 170 may transmit the spoken utterance of the user to the information processor 150. To this end, the audio input interface 141 may be provided with a microphone (not illustrated). The audio input interface 141 may be provided with a plurality of microphones (not illustrated) to more accurately receive spoken utterance of the user. Here, each of the plurality of microphones may be disposed to be spaced apart from each other at different positions, and may process the user's spoken utterance into an electrical signal.

In an alternative embodiment, the voice input interface 141 may use various noise removal algorithms in order to remove noise that is generated in the process of receiving the user's spoken utterance. In an alternative embodiment, the audio input interface 141 may include various elements configured to process an audio signal, such as a filter (not illustrated) configured to remove noise when the user's spoken utterance is received, and an amplifier (not illustrated) configured to amplify and output a signal outputted from the filter.

The audio output unit 142 of the audio processor 140 may, by control of the controller 170, output a warning sound, a notification message regarding an operation mode, an operation state, and an error state, responding information corresponding to the user's speech information, and a processing result corresponding to the spoken utterance (a voice command) of the user, in the form of audio. The audio output interface 142 may convert electric signals received from the controller 170 into audio signals, and output the audio signals. To this end, the audio output interface 142 may be provided with, for example, a speaker.

The information processor 150 may convert a response text, which is generated in response to a spoken utterance of the user, to a spoken response utterance. The information processor 150 may obtain external situation information while outputting the spoken response utterance. The information processor 150 may generate a dynamic spoken response utterance by converting the spoken response utterance on the basis of the external situation information. The information processor 150 may output the dynamic spoken response utterance.

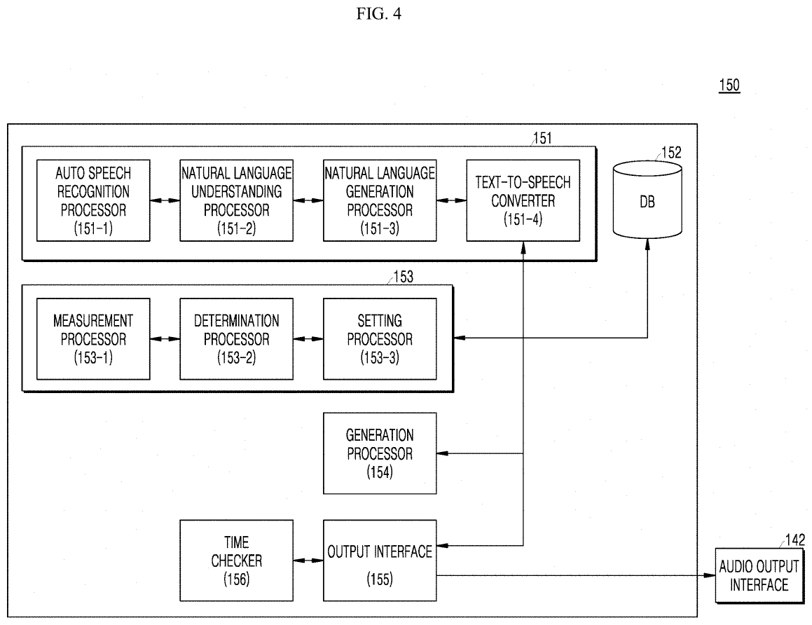

In the present embodiment, the information processor 150 may perform training in connection with the controller 170, or may receive a training result from the controller 170. In the present embodiment, the information processor 150 may be provided outside the controller 170 as illustrated in FIG. 3, or may be provided inside the controller 170 and operate like the controller 170, or may be provided within the server 300 of FIG. 1. Hereinafter, the information processor 150 will be described in greater detail with reference to FIG. 4.

The memory 160 may store therein various information required for operations of the speech processing apparatus 100, and may include a volatile or non-volatile recording medium. For example, the memory 160 may store therein a wake-up word which is preset for determining whether the user's spoken utterance includes the wake-up word. The wake-up word may be set by a manufacturer. For example, “Hi, LG” may be set as the wake-up word, and the user may change the wake-up word. The wake-up word may be inputted in order to activate the speech processing apparatus 100, and the speech processing apparatus 100 that has recognized the wake-up word uttered by the user may switch to a voice recognition activation state.

In addition, the memory 160 may store therein the user's spoken utterance (a wake-up word and a spoken sentence) received through the audio input interface 141 and store information that is sensed by the sensor 130. In addition, the memory 160 may store therein various information required for the operations of the speech processing apparatus 100 and may store control software capable of operating the speech processing apparatus 100.

In addition, the memory 160 may store therein a command to be executed by the information processor 150, including, for example, a command for converting the response text, which is generated in response to the user's spoken utterance, to the spoken response utterance, a command for obtaining the external situation information while outputting the spoken response utterance, a command for generating the dynamic spoken response utterance by converting the spoken response utterance on the basis of the external situation information, and a command for outputting the dynamic spoken response utterance. In addition, the memory 160 may store therein various information processed by the information processor 150.

Here, the memory 160 may include a magnetic storage medium or a flash storage medium, but the scope of the present disclosure is not limited thereto. The memory 160 may include a built-in memory and/or an external memory, and may include a volatile memory such as a DRAM, an SRAM, or an SDRAM, a non-volatile memory such as a one-time programmable ROM (OTPROM), a PROM, an EPROM, an EEPROM, a mask ROM, a flash ROM, a NAND flash memory, or a NOR flash memory, a flash drive such as a solid state disk (SSD) compact flash (CF) card, an SD card, a Micro-SD card, a Mini-SD card, an XD card, or a memory stick, or a storage device such as an HDD.

Here, relatively simple speech recognition may be performed by the speech processing apparatus 100, and relatively complex speech recognition such as natural language processing may be performed by the server 300. For example, when the spoken utterance of the user includes only the preset wake-up word, the speech processing apparatus 100 may activate the speech recognition function and may be switched to a state ready for receiving a spoken sentence. Here, the speech processing apparatus 100 may perform the speech recognition processing up to a stage where it is determined whether the wake-up word has been inputted, and the rest of the speech recognition processing for the spoken sentence may be performed through the server 300. Since system resources of the speech processing apparatus 100 may be limited, natural language recognition and processing, which are relatively complex, may be performed by the server 300.

The controller 170 may transmit the spoken utterance of the user received through the audio input interface 141 to the information processor 150, provide the result of the speech recognition processing from the information processor 150 through the display 121 as visual information or through the audio output interface 142 as auditory information.

The controller 170 may control the entire operation of the speech processing apparatus 100 by driving the control software stored in the memory 160 as a kind of central processing device. The controller 170 may include any type of device capable of processing data, such as a processor. Here, the “processor” may refer to, for example, a data processing device embedded in hardware, which has a physically structured circuit to perform a function represented by codes or instructions included in a program. As examples of the data processing device embedded in hardware, a microprocessor, a central processor (CPU), a processor core, a multiprocessor, an application-specific integrated circuit (ASIC), a field programmable gate array (FPGA), and the like may be included, but the scope of the present disclosure is not limited thereto.

In the present embodiment, the controller 170 may perform machine learning such as deep learning for the spoken utterance of the user so that the speech processing apparatus 100 outputs an optimal result of the speech recognition processing. The memory 160 may store therein, for example, the data that are used in the machine learning and the result data.

Deep learning, which is a subfield of machine learning, enables data-based learning through multiple layers. Deep learning may represent a set of machine learning algorithms that extract core data from a plurality of data sets as the number of layers increases.

Deep learning structures may include an artificial neural network (ANN), and may include a convolutional neural network (CNN), a recurrent neural network (RNN), a deep belief network (DBN), and the like. The deep learning structure according to the present embodiment may use various structures well known in the art. For example, the deep learning structure according to the present disclosure may include a CNN, an RNN, a DBN, and the like. An RNN is widely used in natural language processing and may configure an artificial neural network structure by building up layers at each instant in a structure that is effective for processing time-series data which vary with time. A DBN may include a deep learning structure formed by stacking up multiple layers of restricted Boltzmann machines (RBM), which is a deep learning scheme. When a predetermined number of layers are constructed by repetition of RBM learning, the DBN having the predetermined number of layers may be constructed. A CNN may include a model mimicking a human brain function, which is built under the assumption that when a person recognizes an object, the brain extracts the most basic features of the object and recognizes the object based on the result of complex calculations in the brain.

Meanwhile, learning of an ANN may be performed by adjusting a weight of a connection line (also adjusting a bias value, if necessary) between nodes so that a desired output is achieved with regard to a given input. Also, the ANN may continuously update the weight values through learning. Furthermore, methods such as back propagation may be used in training the ANN.

The controller 170 may be provided with an ANN and perform machine learning-based user recognition and user's voice recognition by using received speech input signals as input data.

The controller 170 may include an ANN, such as a deep neural network (DNN) including a CNN, an RNN, a DBN, and so forth, and may train the DNN. As a machine learning method for an ANN, both unsupervised learning and supervised learning may be used. The controller 170, after learning according to the setting, may control such that a speech tone recognition artificial neural network structure is updated.

FIG. 4 is a schematic block diagram illustrating an information processor 150 of the speech processing apparatus 100 illustrated in FIG. 3, according to an example embodiment. Hereinafter, description overlapping with that of FIGS. 1 to 3 will be omitted. Referring to FIG. 4, the information processor 150 may include a speech recognition processor 151, a database 152, an acquisition processor 153, a generation processor 154, an output interface 155, and a time checker 156. In an alternative embodiment, the information processor 150 may include one or more processors. In a selective embodiment, the speech recognition processor 151, the database 152, the acquisition processor 153, the generation processor 154, the output interface 155, and the time checker 156 may correspond to the one or more processors. In a selective embodiment, the speech recognition processor 151, the database 152, the acquisition processor 153, the generation processor 154, the output interface 155, and the time checker 156 may correspond to software components configured to be executed by the one or more processors.

The speech recognition processor 151 may perform a speech recognition processing for a spoken utterance of a user. In the present embodiment, an auto speech recognition (ASR) processor 151-1, a natural language understanding processor 151-2, a natural language generation processor 151-3, and a text-to-speech (TTS) converter 151-4 may be included in the speech recognition processor 151.

The ASR processor 151-1 may generate a user speech text by converting the spoken utterance of the user. In the present embodiment, the ASR processor 151-1 may perform a speech-to-text (STT) conversion. The ASR processor 151-1 may convert the spoken utterance of the user inputted through the audio input interface 141 to the user speech text. In the present embodiment, the ASR processor 151-1 may include an utterance recognition processor (not illustrated). The utterance recognition processor may include an acoustic model and a language model. For example, the acoustic model may include vocalization-related information, and the language model may include unit phoneme information and information about a combination of the unit phoneme information. The utterance recognition processor may convert the spoken utterance of the user into the user speech text by using the vocalization-related information and the unit phoneme information. Information about the acoustic model and the language model may be stored in, for example, an auto speech recognition database (not illustrated) in the ASR processor 151-1.

The natural language understanding processor 151-2 may analyze a speech intent of the spoken utterance of the user by performing a syntactic analysis or a semantic analysis for the user speech text. Here, the syntactic analysis may divide a query text into syntactic units (for example, words, phrases, and morphemes), and may identify syntactic elements of the divided units. In addition, the semantic analysis may be performed using, for example, a semantic matching, a rule matching, and a formula matching. Accordingly, the natural language understanding processor 151-2 may recognize the intent of the user speech text or may acquire a parameter required for expressing the intent.

The natural language generation processor 151-3 may generate a response text for the user speech text by using a knowledge base on the basis of the speech intent analyzed by the natural language understanding processor 151-2.

The TTS converter 151-4 may generate a spoken response utterance by converting the response text generated by the natural language generation processor 151-3, and then output the spoken response utterance through the audio output interface 142.

While the spoken response utterance is outputted through a speaker, that is, through the audio output interface 142, the acquisition processor 153 may obtain external situation information. In the present embodiment, the acquisition processor 153 may include a measurement processor 153-1, a determination processor 153-2, and a setting processor 153-3.

After the spoken response utterance is outputted, the measurement processor 153-1 may measure noise that is inputted through the microphone, that is, through the audio input interface 141 of FIG. 3, as the external situation information, and then convert the noise to an electric signal. Then, the size of the electric signal converted from the noise may be measured, and decibel (dB) may be used as the unit of measurement. The measurement processor 153-1 may be provided with a device (not illustrated) for measuring noise and/or a noise sensor (not illustrated).

When the measured noise, as the external situation information, inputted through the microphone, that is, through the audio input interface 141 of FIG. 3, exceeds a first reference value (for example, 60 dB), the determination processor 153-2 may determine that the noise is a first noise. When the measured noise exceeds a second reference value (for example, 30 dB) and is less than the first reference value, the determination processor 153-2 may determine that the noise is a second noise.

Here, the first noise of the external situation information may be a noise exceeding the first reference value, and may include direct reaction information of the user (and a listener) for the outputted spoken response utterance. Here, the direct reaction information may include, for example, clapping and acclamation. In addition, the first noise may not be a real noise, but may include an external interruption. The second noise of the external situation information may be a noise that exceeds a second reference value (for example, 30 dB) and is less than the first reference value, and may include indirect audio information of surroundings obtained while the spoken response utterance is outputted. Here, the indirect audio information may include, for example, ambient noise.

The external situation information may include time limit information for setting output time of the spoken response utterance. Here, the setting processor 153-3 may be set by receiving time limit information that is controlled by the user through the operation interface 122 or by receiving a result of a recognition of time limit information included in the spoken utterance of the user.

The generation processor 154 may generate a dynamic spoken response utterance by converting the spoken response utterance on the basis of the external situation information obtained by the acquisition processor 153. The generation processor 154 may generate a first dynamic spoken response utterance by inserting a silent section into the spoken response utterance in response to the first noise obtained by the acquisition processor 153. Here, the database 152 may store therein an applause or acclamation model, and when the first noise has a pattern similar to a pattern of the applause or acclamation stored in the database 152, the generation processor 154 may generate the first dynamic spoken response utterance by inserting a silent section into the spoken response utterance.

The generation processor 154 may generate the first dynamic spoken response utterance until the first noise becomes less than the first reference value, and when the first noise becomes less than the first reference value, may stop inserting the silent section and resume generating the spoken response utterance. In an alternative embodiment, when the first noise exceeds the second reference value and is less than the first reference value after the first dynamic spoken response utterance is outputted, the determination processor 153-2 may determine that the noise is the second noise, and the generation processor 154 may generate a second dynamic spoken response utterance by increasing a volume or pitch of the spoken response utterance. Then, when the second noise becomes less than the second reference value, the generation processor 154 may stop generating the second dynamic spoken response utterance and resume generating the spoken response utterance.

Furthermore, the generation processor 154 may generate the second dynamic spoken response utterance by increasing the volume of the spoken response utterance or by increasing the pitch of the spoken response utterance in response to a determination that the noise is the second noise. The generation processor 154 may generate the second dynamic spoken response utterance by increasing the volume and/or pitch of the spoken response utterance by the size of the second noise.

Furthermore, the generation processor 154 may generate the second dynamic spoken response utterance by increasing a volume of the spoken response utterance or by increasing a pitch of the spoken response utterance until the second noise becomes less than the second reference value, and when the second noise becomes less than the second reference value, the generation processor 154 may stop generating the second dynamic spoken response utterance and resume generating the spoken response utterance.

Furthermore, the generation processor 154 may generate a third dynamic spoken response utterance by changing an output rate of the spoken response utterance on the basis of the time limit information. The change of the output rate of the spoken response utterance may be similar to a video speed conversion (for example, 2× speed or 4x speed); therefore, the detailed description of the change of the output rate will be omitted.

The output interface 155 may output one of the first to third dynamic spoken response utterances or the spoken response utterance generated by the generation processor 154 through the speaker.

The output interface 155 may output a prestored utterance from the database 152, after stopping inserting the silent section and prior to resuming outputting the spoken response utterance. Here, the prestored utterance may be outputted for the purpose of naturally moving on from the silent section to the spoken response utterance. The prestored utterance may include meaningless utterances such as “um,” “ah,” and “well.”

When the output interface 155 receives, from the time checker 156, a signal indicating that the set time included in the time limit information is reached while outputting the third dynamic spoken response utterance, the output interface 155 may stop outputting the third dynamic spoken response utterance. Here, the time checker 156 may count time according to the set time included in the time limit information and transmit the result of the counting of the time to the output interface 155.

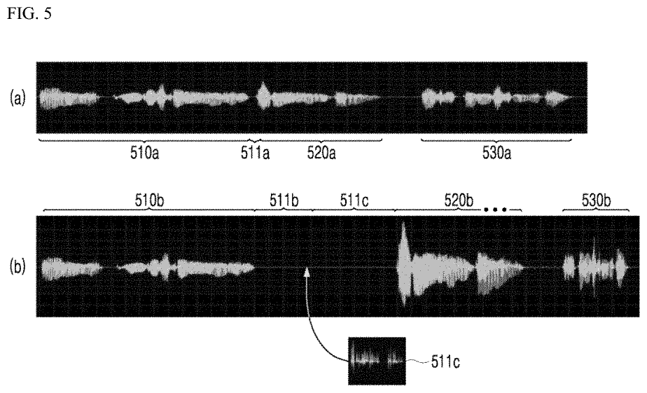

FIG. 5 is an illustration of a dynamic spoken response utterance generated on the basis of external situation information obtained while a spoken response utterance is outputted, according to an exemplary embodiment of the present disclosure. Hereinafter, description overlapping with that of FIGS. 1 to 4 will be omitted.

Referring to FIG. 5, FIG. 5a illustrates spoken response utterances outputted from the TTS converter 151-4, and FIG. 5b illustrates dynamic spoken response utterances generated on the basis of the external situation information.

In FIG. 5a, 510a is a first spoken response utterance, 511a is an interruption section included in the first noise as the external situation information, 520a is a second spoken response utterance, and 530a is a third spoken response utterance.

In FIG. 5b, 510b is a first spoken response utterance, 511b is a silent section inserted in response to the interruption section, and 511c is a prestored utterance inserted before a second dynamic spoken response utterance 520b is outputted. In FIG. 5b, the first spoken response utterance 510b, the silent section 511b, and the prestored utterance 511c may be included in a first dynamic spoken response utterance.

In FIG. 5b, reference numeral “520b” refers to a second dynamic spoken response utterance generated by increasing a volume or pitch of the second spoken response utterance 520a by the size of the second noise, and 530b refers to a third dynamic spoken response utterance generated by changing the output rate of the third spoken response utterance 530a.

The inserting of the silent section 511b included in the first dynamic spoken response utterance may be stopped when the first noise becomes less than the first reference value. Then, the output of the first spoken response utterance 510a of FIG. 5a may be resumed. The generating of the second dynamic spoken response utterance 520b may be stopped when the second noise becomes less than the second reference value, and then the output of the second spoken response utterance 520a may be resumed.

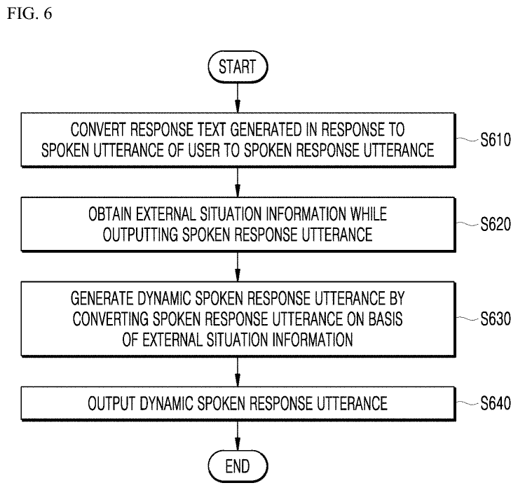

FIG. 6 is a flowchart of a speech processing method according to an exemplary embodiment of the present disclosure. Hereinbelow, description overlapping with that of FIG. 1 through FIG. 5 will be omitted.

Referring to FIG. 6, in step S610, the speech processing apparatus 100 may convert a response text, which is generated in response to a spoken utterance of a user, to a spoken response utterance.

In S620, the speech processing apparatus 100 may obtain external situation information while the spoken response utterance is outputted through a speaker. The speech processing apparatus 100 may measure noise inputted through a microphone as the external situation information, while the spoken response utterance is outputted. The speech processing apparatus 100 may determine a noise that exceeds a first reference value as a first noise, which is direct reaction information of the user (for example, applause or acclamation). The speech processing apparatus 100 may determine a noise that exceeds a second reference value and is less than the first reference value as a second noise, which is indirect audio information of surroundings (for example, an ambient noise, the sound of a passing car, etc.). Furthermore, the speech processing apparatus 100 may obtain time limit information, based on which output of the spoken response utterance should be stopped within a predetermined time.

In S630, the speech processing apparatus 100 may generate a dynamic spoken response utterance by converting the spoken response utterance on the basis of the external situation information. The speech processing apparatus 100 may generate a first dynamic spoken response utterance by inserting a silent section into the spoken response utterance in response to a determination that the noise is the first noise. Furthermore, the speech processing apparatus 100 may generate a second dynamic spoken response utterance by increasing a volume of the spoken response utterance or by increasing a pitch of the spoken response utterance, in response to a determination that the noise is the second noise. Furthermore, the speech processing apparatus 100 may generate a third dynamic spoken response utterance by changing an output rate of the spoken response utterance on the basis of the time limit information. The speech processing apparatus 100 may generate the first dynamic spoken response utterance until the first noise becomes less than the first reference value, and when the first noise becomes less than the first reference value, may stop inserting the silent section and resume outputting the spoken response utterance. When the second noise becomes less than the second reference value after the second dynamic spoken response utterance is generated, the speech processing apparatus 100 may stop generating the second dynamic spoken response utterance and resume generating the spoken response utterance.

In S640, the speech processing apparatus 100 may output the first to third dynamic spoken response utterances through the speaker. The speech processing apparatus 100 may output a prestored utterance, after stopping inserting the silent section and prior to resuming outputting the spoken response utterance. When a set time included in the time limit information is reached after the third dynamic spoken response utterance is outputted, the speech processing apparatus 100 may stop outputting the third dynamic spoken response utterance.

Embodiments according to the present disclosure described above may be implemented in the form of computer programs that may be executed through various components on a computer, and such computer programs may be recorded in a computer-readable medium. Examples of the computer-readable medium may include, but are not limited to: magnetic media such as hard disks, floppy disks, and magnetic tapes; optical media such as CD-ROM disks and DVD-ROM disks; magneto-optical media such as floptical disks; and hardware devices that are specially configured to store and execute program commands, such as ROM, RAM, and flash memory devices.

Meanwhile, the computer programs may be those specially designed and constructed for the purposes of the present disclosure or they may be of the kind well known and available to those skilled in the computer software arts. Examples of the computer programs may include both machine codes produced by a compiler, and higher level language code that may be executed by a computer using an interpreter.

As used in the present disclosure (especially in the appended claims), the singular forms “a,” “an,” and “the” include both singular and plural references, unless the context clearly states otherwise. In addition, the description of a range may include individual values falling within the range (unless otherwise specified), and is the same as describing the individual values forming the range.

The above-mentioned steps constructing the method disclosed in the present disclosure may be performed in a proper order unless explicitly stated otherwise. The present disclosure is not necessarily limited to the order of the steps given in the description. All examples described herein or the terms indicative thereof (“for example,” etc.) used herein are merely to describe the present disclosure in greater detail. Therefore, it should be understood that the scope of the present disclosure is not limited to the exemplary embodiments described above or by the use of such terms unless limited by the appended claims. Also, it should be apparent to those skilled in the art that various modifications, combinations, and alternations can be made depending on design conditions and factors within the scope of the appended claims or equivalents thereof.

Therefore, technical ideas of the present disclosure are not limited to the above-mentioned embodiments, and it is intended that not only the appended claims, but also all changes equivalent to claims, should be considered to fall within the scope of the present disclosure.

The present disclosure described as above is not limited by the aspects described herein and accompanying drawings. It should be apparent to those skilled in the art that various substitutions, changes and modifications which are not exemplified herein but are still within the spirit and scope of the present disclosure may be made. Therefore, the scope of the present disclosure is defined not by the detailed description, but by the claims and their equivalents, and all variations within the scope of the claims and their equivalents are to be construed as being included in the present disclosure.

What is claimed is:

1. A speech processing method, comprising:
converting a response text, which is generated in response to a spoken utterance of a user, to a spoken response utterance;
obtaining external situation information while outputting the spoken response utterance;
generating a dynamic spoken response utterance by converting the spoken response utterance on the basis of the external situation information; and
outputting the dynamic spoken response utterance.

2. The speech processing method according to claim 1, wherein obtaining the external situation information comprises:
measuring noise, as the external situation information, inputted through a microphone after outputting the spoken response utterance;
determining a noise that exceeds a first reference value as a first noise, which is direct response information of the user; and
determining a noise that exceeds a second reference value and is less than the first reference value as a second noise, which is indirect audio information of surroundings.

3. The speech processing method according to claim 2, wherein generating the dynamic spoken response utterance comprises generating a first dynamic spoken response utterance by inserting a silent section into the spoken response utterance in response to a determination that the noise is the first noise.

4. The speech processing method according to claim 3, wherein generating the dynamic spoken response utterance comprises:
generating the first dynamic spoken response utterance until the first noise becomes less than the first reference value; and
when the first noise becomes less than the first reference value, stopping inserting the silent section and resuming generating the spoken response utterance.

5. The speech processing method according to claim 4, further comprising outputting a prestored utterance after stopping inserting the silent section and prior to resuming outputting the spoken response utterance.

6. The speech processing method according to claim 2, wherein generating the dynamic spoken response utterance comprises generating a second dynamic spoken response utterance by increasing a volume of the spoken response utterance or by increasing a pitch of the spoken response utterance in response to a determination that the noise is the second noise.

7. The speech processing method according to claim 6, wherein generating the dynamic spoken response utterance comprises:
generating the second dynamic spoken response utterance until the second noise becomes less than the second reference value; and
when the second noise becomes less than the second reference value, stopping generating the second dynamic spoken response utterance and resuming generating the spoken response utterance.

8. The speech processing method according to claim 1, wherein obtaining the external situation information comprises obtaining time limit information, based on which output of the spoken response utterance should be stopped within a predetermined time.

9. The speech processing method according to claim 8, wherein generating the dynamic spoken response utterance comprises generating a third dynamic spoken response utterance by changing an output rate of the spoken response utterance on the basis of the time limit information.

10. A computer-readable recording medium on which a computer program is stored for implementing the method according to claim 1 using a computer.

11. A speech processing apparatus comprising one or more processors configured to:
convert a response text, which is generated in response to a spoken utterance of a user, to a spoken response utterance;
obtain external situation information while outputting the spoken response utterance;
generate a dynamic spoken response utterance by converting the spoken response utterance on the basis of the external situation information; and
output the dynamic spoken response utterance.

12. The speech processing apparatus according to claim 11, wherein, while obtaining the external situation information, the one or more processors are configured to:
measure noise, as the external situation information, inputted through a microphone after outputting the spoken response utterance;
determine a noise that exceeds a first reference value as a first noise, which is direct response information of the user; and
determine a noise that exceeds a second reference value and is less than the first reference value as a second noise, which is indirect audio information of surroundings.

13. The speech processing apparatus according to claim 12, wherein, while generating the dynamic spoken response utterance, the one or more processors are configured to generate a first dynamic spoken response utterance by inserting a silent section into the spoken response utterance in response to a determination that the noise is the first noise.

14. The speech processing apparatus according to claim 13, wherein, while generating the dynamic spoken response utterance, the one or more processors are configured to:
generate the first dynamic spoken response utterance until the first noise becomes less than the first reference value; and
when the first noise becomes less than the first reference value, stop inserting the silent section and resume generating the spoken response utterance.

15. The speech processing apparatus according to claim 14, wherein the one or more processors are configured to output a prestored utterance, after stopping inserting the silent section and prior to resuming generating the spoken response utterance.

16. The speech processing apparatus according to claim 12, wherein while generating the dynamic spoken response utterance, the one or more processors are configured to generate a second dynamic spoken response utterance by increasing a volume of the spoken response utterance or by increasing a pitch of the spoken response utterance in response to a determination that the noise is the second noise.

17. The speech processing apparatus according to claim 16, wherein, while generating the dynamic spoken response utterance, the one or more processors are configured to generate the second dynamic spoken response utterance until the second noise becomes less than the second reference value; and when the second noise becomes less than the second reference value, stop generating the second dynamic spoken response utterance and resume generating the spoken response utterance.

18. The speech processing apparatus according to claim 11, wherein, while obtaining the external situation information, the one or more processors are configured to obtain time limit information, based on which output of the spoken response utterance should be stopped within a predetermined time.

19. The speech processing apparatus according to claim 18, wherein, while generating the dynamic spoken response utterance, the one or more processors are configured to generate a third dynamic spoken response utterance by changing an output rate of the spoken response utterance on the basis of the time limit information.
